(19) United States
(12) Patent Application Publication
(10) Pub. No.: US 2006/0034995 A1
(43) Pub. Date: Feb. 16, 2006

(54) Shredded cheese product and method of making the same

(76) Inventors: Kim M. DeSmidt, Plymouth, WI (US); Gerard J. Hogan, Kohler, WI (US); Brian L. Kaufman, Cascade, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 10/918,892

(22) Filed: Aug. 16, 2004

(51) Int. Cl. A23C 19/00

(52) U.S. Cl. 426/582

(57) ABSTRACT

A shredded cheese product blend and a method of making such a shredded cheese product blend is disclosed in which the blend is a mixture of one or more types of shredded cheese and one or more kinds of vegetable and/or fruit particles, and optionally also includes one or more spices. One or more shredded cheeses are blended with one or more vegetable and/or fruit particles having reduced moisture content in selected relative amounts, with the shredded cheese product blend then being packaged in a conventional manner. A variety of different cheeses can be shredded, or a blend of two or more cheeses can be shredded and mixed together. A number of different vegetables and/or fruits can be used, and combinations of two or more vegetables and/or fruits can be particularized and mixed together.

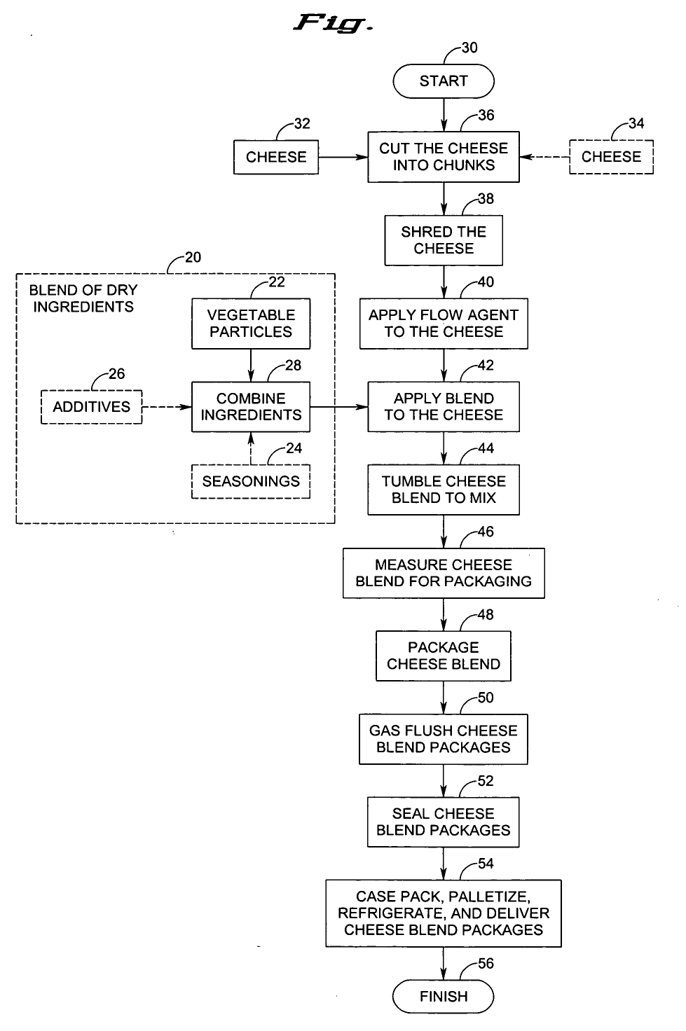

### BACKGROUND OF THE INVENTION

### FIELD OF THE INVENTION

The present invention relates generally to shredded cheeses, and more particularly to new and unique blends of one or more types of shredded cheese with vegetable particles which may also include spices, together with a method for the manufacture of such shredded cheese product blends.

Shredded cheese has become tremendously popular since its initial introduction in 1958 by the assignee of the invention described herein. Shredded cheese achieved instant recognition as a highly convenient product which has a wide variety of uses, ranging from a topping for pizzas to its use in various types of casseroles to an ingredient for salads to its inclusion in a wide variety of ethnic foods including Italian and Mexican cuisine. Its popularity has been increased by convenient packaging, beginning with the packaging of shredded cheese in peg bar bags in 1967 and the resealable zippered bag in 1986, both of which innovations were also introduced by the assignee of the invention described herein.

While initially only a few cheeses were available in shredded form, combinations of more than one type of cheese in shredded cheese blends have been available since 1994. In a more recent innovation, spices have been added to shredded cheeses for applications in ethnic foods such as Mexican food, with such blends including taco shredded cheese and taco and nacho shredded cheese. Both of these cheese lend innovations were also introduced by the assignee of the invention described herein.

It will be appreciated that the innovations which relate to shredded cheese products have fallen into two major categories: packaging which makes the purchase, storage, and use of shredded cheese products easier and more convenient; and improvements to and variations in the shredded cheese products themselves. In the latter category, the innovations in shredded cheese products which have been made to date have significantly expanded the number of applications for shredded cheese products, and have also provided an increased level of convenience to consumers. It is believed that further shredded cheese product innovations in this area will present consumers with additional choices and menu inspirations, and that it accordingly represents a fertile area for additional product innovations.

It is accordingly the primary objective of the present invention that it present one or more shredded cheese products which are blends of one or more shredded cheeses and one or more vegetable particles in selected relative amounts. It is a related objective of the present invention that the shredded cheese product blends are pleasing to the palate (tasty) as well as being pleasing to the eye (the ingredients of each blend present aesthetically attractive color combinations). It is a further related objective of the present invention that the shredded cheese(s) and the vegetable particles of each of the shredded cheese product blends are evenly distributed throughout the blends in a uniform manner.

It is another objective of the present invention that the shredded cheese product blends present multiple applications to consumers so that each shredded cheese product blend has multiple potential uses in different applications. It is yet another objective of the present invention that it contemplate different shredded cheese product blend variations, including both different cheeses or combinations of cheeses and/or different vegetable particles or combinations of vegetable particles. It is still another objective of the present invention that the shredded cheese product blends may optionally include spices which may be added to supplement the blend of cheese(s) and vegetable particles.

The shredded cheese product blends of the present invention must also be of high quality and must also remain fresh both before and after the packaging is opened, and they should also require little other than refrigeration to keep them fresh over an extended time period. In order to enhance the market appeal of the shredded cheese product blends of the present invention, they should also be of comparable cost to conventional shredded cheeses to thereby afford them the broadest possible market. Finally, it is also an objective that all of the aforesaid advantages and objectives of the shredded cheese product blends of the present invention be achieved without incurring any substantial relative disadvantage.

### SUMMARY OF THE INVENTION

The disadvantages and limitations of the background art discussed above are overcome by the present invention. With this invention, one or more shredded cheeses are blended with one or more vegetable and/or fruit particles having reduced moisture content in selected relative amounts, with the shredded cheese product blend then being packaged in a conventional manner. There can be a variety of different cheeses which are shredded, or a blend of two or more cheeses can be shredded and mixed together. Similarly, there are a number of different vegetables and/or fruit which can be used, and combinations of two or more vegetables and/or fruit can be particularized and mixed together.

Those skilled in the art will appreciate the inclusion of fruit, since there are a number of items which are considered by some to be vegetables and by others to be fruits. For example, tomatoes, which are one of the items which will be used, are considered to vegetables, but there is a substantial minority that maintains that tomatoes are fruit. Another such example is the pepper, which while considered by most people to be a vegetable, has been declared by the scientific community to be the fruit of the pepper plant. It will be understood that from this point forward, when the term “vegetable” is used herein, it is to be read in an inclusive manner to also include fruit.

Referring first to the shredded cheeses, any of a variety of cheeses can be shredded to serve as the base for the shredded cheese product blends of the present invention. For example, mozzarella, Monterrey Jack, asiago, Colby, cheddar, and Colby-Jack cheeses can all be shredded and used as the base for the shredded cheese product blends. Additionally, blends of two or more cheeses can also be used as the base for the shredded cheese product blends. In addition, imitation cheeses and vegan cheeses can also be used as the base for the shredded cheese product blends, so the term “cheese” as used herein should be broadly interpreted to include such products.

The nature of the shredding can also vary, with chef style or fancy style shreds being used for different blends. Chef style shreds are both larger in cross-sectional configuration (a coarser shred) and longer than fancy style shreds. Chef style shreds may be, for example, diamond shaped in cross-section, with a width of approximately 0.155 inches and a height of approximately 0.095 inches to 0.130 inches, and may have a length of one inch to two inches or even longer. Fancy style shreds, on the other hand, may be, for example, diamond shaped in cross-section, with a width of approximately 0.090 inches and a height of approximately 0.065 inches to 0.080 inches, and may have a length of 0.75 inches to 1.5 inches.

With regard to the vegetable particles, a number of different vegetables can be particularized and added to the shredded cheese(s). For example, sun-dried tomatoes, garlic, basil, dehydrated tomatoes, cilantro, jalapenos, or combinations thereof, can be used. Other vegetables could be used as well, with likely candidates being peppers (both hot peppers and sweet peppers), mushrooms, onions, etc. Another vegetable-based item which could be used is imitation bacon bits or chips (alternatively, real bacon bits could be used instead of imitation bacon). Alternately or in addition, dried fruit particles or granules could be used, such as apples, or any other fruit which when blended with cheese is appetizing.

It will be appreciated by those skilled in the art that several of the vegetables (such as garlic basil, cilantro, jalapenos, and oregano, for example) are also highly savory flavorings and thus will serve as both vegetable particles and spices when added to shredded cheese. Other vegetables to be used (such as sun-dried tomatoes, dehydrated tomatoes, sweet peppers, mushrooms, and onions, for example) may be supplemented with spices which complement the particular vegetable or combination of vegetables.

Examples of spices which can be used include salsa verde seasoning (which includes a variety of powdered vegetables such as tomatoes, onions, bell peppers, cilantro, garlic, celery, and parsley), salt, pepper, basil, oregano, and sugar. Alternately, a vegetable which does not have seasoning characteristics could instead be used with another vegetable which does have seasoning characteristics (for example, using basil and/or oregano with sun-dried tomatoes).

The vegetable(s) or vegetable(s) and spices are combined with the shredded cheese in desired proportions and mixed thoroughly. In the shredded cheese product blends of the present invention, the amount of shredded cheese can vary between approximately eighty percent and approximately ninety-nine and one-half percent by weight of the total weight of the mixture. The amount of dried vegetables can vary between approximately one-half percent and approximately twenty percent by weight of the total weight of the mixture. The amount of spices can vary between approximately zero (where the vegetable being used has seasoning characteristics) and approximately seven and one-half percent by weight of the total weight of the mixture.

In the preferred embodiment of the present invention, the amount of shredded cheese can vary between approximately ninety percent and ninety-nine and one-half percent by weight of the total weight of the mixture. The amount of dried vegetables can vary between approximately one-half percent and ten percent by weight of the total weight of the mixture. The amount of spices can vary between approximately zero (where the vegetable being used has seasoning characteristics) and three and three-quarters percent by weight of the total weight of the mixture.

After the shredded cheese and the vegetables are mixed thoroughly, the shredded cheese product blends of the present invention are packaged as is conventional. For consumer applications, the shredded cheese product blends of the present invention are preferably packaged in resealable bags.

It may therefore be seen that the present invention teaches shredded cheese products which are blends of one or more shredded cheeses and one or more vegetable particles in selected relative amounts. The shredded cheese product blends of the present invention are pleasing to the palate (tasty) as well as being pleasing to the eye (the ingredients of each blend present aesthetically attractive color combinations). The shredded cheese(s) and the vegetable particles of each of the shredded cheese product blends of the present invention are evenly distributed throughout the shredded cheese product blends in a uniform manner.

The shredded cheese product blends of the present invention present multiple applications to consumers so that each shredded cheese product blend has multiple potential uses in different applications. The shredded cheese product blends of the present invention also contemplate different shredded cheese product blend variations, including both different cheeses or combinations of cheeses and/or different vegetable particles or combinations of vegetable particles. The shredded cheese product blends of the present invention may optionally include spices which may be added to supplement the blend of cheese(s) and vegetable particles.

The shredded cheese product blends of the present invention are of high quality and will remain fresh both before and after the packaging is opened, requiring only refrigeration to keep them fresh over an extended time period. The shredded cheese product blends of the present invention are of comparable cost to conventional shredded cheeses to enhance their market appeal and to thereby afford them the broadest possible market. Finally, all of the aforesaid advantages and objectives of the shredded cheese product blends of the present invention are achieved without incurring any substantial relative disadvantage.

### DESCRIPTION OF THE DRAWING

These and other advantages of the present invention are best understood with reference to the drawing, in which:

The FIGURE is a schematic flow diagram which shows a method for the manufacture of shredded cheese product blends according to the teachings of the present invention.

### DETAILED DESCRIPTION OF THE PREFERRED EMBODIMENT

The preferred embodiment of the present invention includes one or more shredded cheeses which are blended with one or more vegetable particles having a reduced moisture content in selected relative amounts. Optionally, one or more spices can also be added to the shredded cheese product blend. The resulting shredded cheese product blend may then be packaged in a conventional manner.

In the preferred embodiment, the final mixing step consists of mixing two primary ingredients together—the first primary ingredient being the shredded cheese or blend of shredded cheeses, and the second primary ingredient being the vegetable particles or mixture of vegetable particles and the spice or spices. The second primary ingredient is generally formulated first, given that due to its low moisture content it has a substantially longer shelf life than shredded cheese.

The second primary ingredient is illustrated in the FIGURE as a dry ingredients blend 20. The dry ingredient blend consists of vegetable particles 22 (which may be particles of a single vegetable or intermixed particles of multiple vegetables), optional seasonings 24, and optional additives 26 are combined and thoroughly intermixed in a combine ingredients step 28.

The vegetable particles 22 must have a moisture content which is less than approximately twenty-five percent, which corresponds to an Equilibrium Relative Humidity (ERH—a term used to describe the availability of water in foods to the chemical environment and microorganisms present in foods) of sixty percent or less. Foods must be dried to below sixty percent ERH and kept in a dry environment to be shelf stable from microbial growth, because microorganisms cannot survive below an ERH level of approximately sixty, which corresponds with a moisture content of approximately twenty-five percent in vegetables. In the preferred embodiment, the vegetable particles 22 should have a moisture content of approximately ten percent or less, and with some vegetables it is preferred that the moisture content be closer to approximately five percent or less.

With regard to the size of the vegetable particles 22, they are less than three-quarters of an inch (19 mm) in each dimension or smaller, and preferably less than three-eighths of an inch (9.525 mm) in each dimension or smaller, and in the preferred embodiment they are approximately one-eighth of an inch (3.175 mm) in each dimension or smaller. Typically, the vegetable particles 22 are pieces of random size, within the preferred maximum size range. The size of the vegetable particles 22 can vary according to what vegetable the vegetable particles 22 are—for example, it may be desirable to have particles of certain vegetables such as tomatoes or sun-dried tomatoes be larger than particles of other vegetables such as garlic, basil, oregano, or parsley. Other vegetables such as mushrooms, onions, and bell peppers could either be larger or smaller, depending upon the particular application.

The present invention contemplates a number of vegetables potentially being used in the vegetable particles 22, including sun-dried tomatoes, garlic, basil, dehydrated tomatoes, cilantro, jalapenos, peppers (both hot peppers and sweet peppers), mushrooms, onions, etc. Other vegetables could also be used, with the imagination of the blender being the only limitation. Imitation bacon bits or chips which are vegetable-based could also be used (and real bacon bits could be substituted for the artificial bacon bits. Additionally, dried fruit particles could also be used, with apple bits being perhaps the best example of a fruit particle which would blend well with shredded cheese. Finally, those skilled in the art will rapidly appreciate that blends of a number of different vegetables could also be used as the vegetable particles 22.

The present invention contemplates a number of vegetables potentially being used in the seasonings 24, some of which are vegetables which possess strong flavoring characteristics, such as garlic basil, cilantro, jalapenos, and oregano. Other examples of spices which can be used as the seasonings 24 are salt, pepper, basil, oregano, sugar, and powdered vegetables such as tomatoes, onions, bell peppers, cilantro, garlic, celery, and parsley. It will also be understood by those skilled in the art that the art of flavoring is a highly complex art, and that a wide variety of other spice components can also be added to the seasonings 24, all of which are within the scope of the present invention.

The present invention contemplates a number of different ingredients potentially being used in the additives 26, which can serve as a preservative to maintain freshness of the vegetable particles 22, a coloring agent to enhance or preserve color of the vegetable particles 22, an anticaking agent to prevent the seasonings 24 from clumping together, and a taste enhancers which bring out the flavor in the vegetable particles 22 and/or the seasonings 24. Examples of the additives 26 are sulfur dioxide or other sulfites (a preservative and color retention agent), silicon dioxide (an anticaking agent), and monosodium glutamate (a flavor enhancer). It will of course be understood by those skilled in the art that the art of additives is a highly complex art, and that a wide variety of other food additives can also be added to the additives 26, all of which are within the scope of the present invention.

The process of manufacturing the shredded cheese product blends of the present invention may now be described, beginning with a process initiation step 30. Either a single kind of cheese 32 can be used as the basis of a shredded cheese product blend, or multiple different kinds of cheese can be used. In the example shown in the FIGURE, a second kind of cheese 34 is shown as an optional ingredient, although those skilled in the art will at once realize that more than two kinds of cheese could also be used with no departure from the teachings of the present invention from the use of the two cheeses 32 and 34.

The cheese 32 or the cheeses 32 and 34 are first cut into chunks which can be processed in a cut cheese into chunks step 36. This is necessary due to the fact that cheese is typically received by a cheese processing facility on pieces which are too large to fit into a cheese shredding machine. Accordingly, the large pieces of the cheeses 32 and 34 are cut into chunks of a suitable size for shredding in the cut cheese into chunks step 36. It will be appreciated by those skilled in the art that the cut cheese into chunks step 36 may not be necessary if the machines used for shredding can accommodate any size chunks of cheese, or if the chunks are manufactured in a size which is suitable for use in the shredding operation without the necessity of cutting them into smaller chunks.

Next, the chunks of the cheeses 32 and 34 are shredded in a cheese shredding step 38. The type of shredding is selected according to the desired characteristics of the finished product. While both chef style shreds and fancy style shreds are typically diamond shaped in cross-section, chef style shreds are both larger in cross-sectional configuration (a coarser shred) and longer than fancy style shreds. Chef style shreds are typically approximately 0.155 inches (3.9 mm) wide and approximately 0.095 inches (2.4 mm) to 0.130 inches (3.3 mm) high, and one inch (25.4 mm) to two inches (50.8 mm) long, or even longer. Fancy style shreds are typically approximately 0.090 inches (2.3 mm) wide and approximately 0.065 inches (1.7 mm) to 0.080 inches (2 mm) high, and 0.75 inches (19 mm) to 1.5 inches (38 mm) long.

Technically, shredding is an operation which uses a formed metal plate having holes with the metal raised around a portion of each hole to act as cutting edges to cut shreds when the formed metal plate is rotated or otherwise driven. Other types of cutting tools also exist which can create “shreds” of cheese, and although these other tools are not shredders in the classic sense, they create small pieces of cheese which have all of the characteristics of shreds in that they are relatively longer than their cross-sectional configuration. Such shreds and cutting tools are certainly considered to be within the scope of the present invention, and the term “shredded cheese” should be read to be inclusive of such alternative configuration cheese particles.

In the preferred embodiment of the cheese shredding step 38, a flow agent is applied to the shredded cheese to keep it from clumping together in a flow agent application step 40. The flow agent, which may also be referred to as an anticaking agent, is typically either starch-based or cellulose-based. In the preferred embodiment, a combination of potato starch and powdered cellulose are added to the shredded cheese as a flow agent. Optionally, a mold inhibitor such as natamycin, which is an antimyotic food additive used to protect cheese from mold and yeast growth, may also be added. It will be appreciated by those skilled in the art that the use of a flow agent is optional, and may not be required with certain types or blends of cheese. Additionally, the flow agent application step 40 could occur after the addition of the dry ingredients blend 20, or the flow agent may be instead be incorporated into the dry ingredients blend 20 as an additive 26.

Next, the dry ingredients blend 20, including the vegetable particles 22, the seasonings 24, and the additives 26, are added to the shredded cheese in an apply blend to cheese step 42. In this step, the relative amounts of the shredded cheese and the blended dry ingredients are controlled to achieve the proper percentages of each in the resulting cheese blend. In the preferred embodiment, the amount of shredded cheese in the shredded cheese product blends can vary between approximately eighty percent and approximately ninety-nine and one-half percent by weight of the total weight of the mixture. Those skilled in the art will appreciate that it is also possible to add the individual components of the dry ingredients blend 20 to the shredded cheese by metering each ingredient individually into the mix.

In the preferred embodiment, the amount of the vegetable particles 22 in the shredded cheese product blends can vary between approximately one-half percent and approximately twenty percent by weight of the total weight of the mixture. In the preferred embodiment, the amount of the seasonings 24 in the shredded cheese product blends can vary between approximately zero (typically where the vegetable being used has seasoning characteristics) and approximately seven and one-half percent by weight of the total weight of the mixture. Generally, the cost of the vegetable particles 22 and the cost of the seasonings 24 are significantly higher by weight than the cost of the shredded cheese, so the objective is to put a sufficient amount of the dry ingredients blend 20 into the shredded cheese product blends to achieve the desired characteristics, but no more due simply to the economics of manufacturing the shredded cheese product blends of the present invention.

Next, the shredded cheese and the dry ingredients blend 20 are tumbled to mix it in a mix ingredients step 44, which may be performed in a large drum with baffles. Following this step, the shredded cheese product blend is measured for packaging in a measure for packaging step 46, and then is packaged in a package cheese blend step 48. Packaging for commercial use is typically large containers, while packaging for consumer sale is typically resealable bags. The latter will be used in the example discussed in conjunction with the FIGURE. It should be noted that with some types of dry ingredients, it is possible to add them to the shredded cheese in the packaging step 46 instead of earlier in the process.

Following the resealable bags being filled with one of the shredded cheese product blends of the present invention, they are gas flushed in a gas flush packages step 50 to purge oxygen from the resealable bags to maintain freshness and retard spoilage as long as possible. Typically, the gas used in the gas flush packages step 50 is a blend of carbon dioxide (twenty percent) and nitrogen (eighty percent), which is applied with wands which go into the top of the resealable bags (which have not yet been sealed. The gas blend is heavier than oxygen (or air containing oxygen), so the oxygen will be purged from the resealable bags. Those skilled in the art will appreciate that with certain types of cheeses and blends, it may not be necessary to have the gas flush packages step 50.

Next, the resealable bags are sealed in a seal packages step 52, as is conventional. The sealed resealable bags are then typically case packed, palletized, refrigerated, and ultimately delivery to grocery stores for purchase by consumers, all of which is performed in a pack, palletize, refrigerate, and deliver step 54. This completes the process of manufacturing the shredded cheese product blends of the present invention. Several examples of specific shredded cheese product blends which may be made according to the teachings of the present invention will now be described.

### EXAMPLE 1

The first example of a shredded cheese product blend made according to the teachings of the present invention is a mozzarella with sun-dried tomato and basil blend. This blend includes approximately 96.8 percent by weight chef style mozzarella, and approximately 3.2 percent by weight dry ingredients blend which includes sun-dried tomatoes, basil, oregano, and salt, with sulfur dioxide added as a preservative. The dry ingredients blend may vary between approximately one percent and approximately ten percent in this blend, and preferably contains less than approximately ten percent moisture. The sun-dried tomatoes make up from approximately 0.6 percent to approximately 6.3 percent of the shredded cheese product blend by weight, with the spices (basil, oregano, and salt) collectively making up approximately 0.4 percent to approximately 7.3 percent of the shredded cheese product blend by weight.

### EXAMPLE 2

The second example of a shredded cheese product blend made according to the teachings of the present invention is a mozzarella and asiago with roasted garlic blend. This blend includes approximately 68.8 percent by weight fancy style mozzarella, approximately thirty percent by weight fancy style asiago, and approximately 1.25 percent by weight roasted garlic granules. The roasted garlic granules may vary between approximately one-half percent and approximately five percent in this blend (with the shredded cheeses making up the balance), and preferably contains less than approximately 4.5 percent moisture.

### EXAMPLE 3

The third example of a shredded cheese product blend made according to the teachings of the present invention is a cheddar salsa with tomato and jalapeno peppers blend. This blend includes approximately ninety-five percent by weight chef style mild cheddar, and approximately five percent by weight dry ingredients salsa verde blend which includes dehydrated tomato granules and low dust salsa verde seasoning. The dry ingredients blend may vary between approximately one percent and approximately ten percent in this blend. The tomato granules make up from approximately 0.35 percent to approximately 3.5 percent of the shredded cheese product blend by weight, with the salsa verde seasoning making up approximately 0.65 percent to approximately 6.5 percent of the shredded cheese product blend by weight.

### EXAMPLE 4

The fourth example of a shredded cheese product blend made according to the teachings of the present invention is a Monterey Jack with cilantro blend. This blend includes approximately ninety-five percent by weight chef style Monterey Jack, and approximately five percent by weight dry ingredients blend which includes dried cilantro and green salsa seasoning. The dry ingredients blend may vary between approximately one percent and approximately ten percent in this blend. The dried cilantro makes up from approximately 0.06 percent to approximately 0.6 percent of the shredded cheese product blend by weight, with the green salsa seasoning making up approximately 0.94 percent to approximately 9.4 percent of the shredded cheese product blend by weight.

### EXAMPLE 5

The fifth example of a shredded cheese product blend made according to the teachings of the present invention is a cheddar bacon blend. This blend includes approximately ninety-five percent by weight chef style cheddar, and approximately five percent by weight bacon bits (vegetable-based or real). The bacon bits may vary between approximately one percent and approximately ten percent in this blend (with the shredded cheeses making up the balance).

It may therefore be appreciated from the above detailed description of the preferred embodiment of the present invention that it teaches shredded cheese products which are blends of one or more shredded cheeses and one or more vegetable particles in selected relative amounts. The shredded cheese product blends of the present invention are pleasing to the palate (tasty) as well as being pleasing to the eye (the ingredients of each blend present aesthetically attractive color combinations). The shredded cheese(s) and the vegetable particles of each of the shredded cheese product blends of the present invention are evenly distributed throughout the shredded cheese product blends in a uniform manner.

The shredded cheese product blends of the present invention present multiple applications to consumers so that each shredded cheese product blend has multiple potential uses in different applications. The shredded cheese product blends of the present invention also contemplate different shredded cheese product blend variations, including both different cheeses or combinations of cheeses and/or different vegetable particles or combinations of vegetable particles. The shredded cheese product blends of the present invention may optionally include spices which may be added to supplement the blend of cheese(s) and vegetable particles.

The shredded cheese product blends of the present invention are of high quality and will remain fresh both before and after the packaging is opened, requiring only refrigeration to keep them fresh over an extended time period. The shredded cheese product blends of the present invention are of comparable cost to conventional shredded cheeses to enhance their market appeal and to thereby afford them the broadest possible market. Finally, all of the aforesaid advantages and objectives of the shredded cheese product blends of the present invention are achieved without incurring any substantial relative disadvantage.

Although the foregoing description of the shredded cheese product blends of the present invention have been shown and described with reference to particular embodiments and applications thereof, they has been presented for purposes of illustration and description and are not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A shredded cheese product blend, comprising:
cheese shreds having a desired approximate size and configuration; and
vegetable and/or fruit particles having a desired approximate size and having a moisture content which is less than approximately twenty-five percent;
wherein said cheese shreds and said vegetable and/or fruit particles are mixed together in a predetermined ratio and blended to produce a relatively intermingled shredded cheese product blend.

2. A shredded cheese product blend as defined in claim 1, wherein said cheese shreds are chef style cheese shreds.

3. A shredded cheese product blend as defined in claim 1, wherein said cheese shreds are fancy style cheese shreds.

4. A shredded cheese product blend as defined in claim 1, wherein said cheese shreds are made of a cheese from the group consisting of mozzarella, Monterrey Jack, asiago, Colby, cheddar, and Colby-Jack.

5. A shredded cheese product blend as defined in claim 1, wherein said cheese shreds are made from at least two different cheeses in a predetermined ratio.

6. A shredded cheese product blend as defined in claim 1, wherein said vegetable and/or fruit particles have a moisture content which is less than approximately ten percent.

7. A shredded cheese product blend as defined in claim 6, wherein said vegetable and/or fruit particles have a moisture content which is less than approximately five percent.

8. A shredded cheese product blend as defined in claim 1, wherein said vegetable and/or fruit particles measure approximately three-quarters of an inch (19 mm) in each dimension or less.

9. A shredded cheese product blend as defined in claim 8, wherein said vegetable and/or fruit particles measure approximately three-eighths of an inch (9.525 mm) in each dimension or less.

10. A shredded cheese product blend as defined in claim 9, wherein said vegetable and/or fruit particles measure approximately one-eighth of an inch (3.175 mm) in each dimension or less.

11. A shredded cheese product blend as defined in claim 1, wherein said vegetable and/or fruit particles comprise a vegetable and/or fruit from the group consisting of sun-dried tomatoes, garlic, basil, dehydrated tomatoes, cilantro, jalapenos, hot peppers, sweet peppers, mushrooms, onions, and oregano.

12. A shredded cheese product blend as defined in claim 1, wherein said vegetable and/or fruit particles are made from at least two different vegetables and/or fruits in a predetermined ratio.

13. A shredded cheese product blend as defined in claim 1, wherein the amount of shredded cheese in said predetermined ratio is between approximately eighty percent and approximately ninety-nine and one-half percent by weight of the total weight of the shredded cheese product blend, and wherein the amount of dried vegetables and/or fruits in said predetermined ratio is between approximately one-half percent and approximately twenty percent by weight of the total weight of the shredded cheese product blend.

14. A shredded cheese product blend as defined in claim 13, wherein the amount of shredded cheese in said predetermined ratio is between approximately ninety percent and approximately ninety-nine and one-half percent by weight of the total weight of the shredded cheese product blend, and wherein the amount of dried vegetables and/or fruits in said predetermined ratio is between approximately one-half percent and approximately ten percent by weight of the total weight of the shredded cheese product blend.

15. A shredded cheese product blend as defined in claim 14, wherein the amount of shredded cheese in said predetermined ratio is between approximately ninety-five percent and approximately ninety-nine and one-half percent by weight of the total weight of the shredded cheese product blend, and wherein the amount of dried vegetables and/or fruits in said predetermined ratio is between approximately one-half percent and approximately five percent by weight of the total weight of the shredded cheese product blend.

16. A shredded cheese product blend as defined in claim 1, additionally comprising:
at least one seasoning, wherein said cheese shreds, said vegetable and/or fruit particles, and
said at least one seasoning are mixed together in a predetermined ratio and blended to produce a relatively intermingled shredded cheese product blend.

17. A shredded cheese product blend as defined in claim 16, wherein said at least one seasoning is a seasoning from the group consisting of garlic, basil, cilantro, jalapenos, oregano, tomato powder, onion powder, bell peppers, cilantro, garlic, celery, parsley, salt, pepper, and sugar.

18. A shredded cheese product blend as defined in claim 16, wherein said at least one seasoning comprises:
a dried vegetable and/or fruit.

19. A shredded cheese product blend as defined in claim 16, wherein the amount of said at least one seasoning in said predetermined ratio is between approximately zero percent and approximately seven and one-half percent by weight of the total weight of the shredded cheese product blend.

20. A shredded cheese product blend as defined in claim 1, additionally comprising:
an additive which either serves as a preservative, a coloring agent, an anticaking agent, or a taste enhancer.

21. A shredded cheese product blend, comprising:
cheese shreds having a desired approximate size and configuration;
vegetable and/or fruit particles having a desired approximate size and having a moisture content which is less than approximately twenty-five percent;
at least one seasoning, wherein said cheese shreds, said vegetable and/or fruit particles, and said at least one seasoning are mixed together in a predetermined ratio and blended to produce a relatively intermingled shredded cheese product blend; and
an additive which either serves as a preservative, a coloring agent, an anticaking agent, or a taste enhancer;
wherein said cheese shreds, said vegetable and/or fruit particles, said at least one seasoning, and said additive are mixed together in a predetermined ratio and blended to produce a relatively intermingled shredded cheese product blend.

22. A shredded cheese product blend, comprising:
approximately 80% to approximately 99.5% by weight shredded cheese; and
approximately 0.5% to approximately 20% by weight vegetable and/or fruit particles having a moisture content which is less than approximately twenty-five percent;
wherein said shredded cheese and said vegetable and/or fruit particles are mixed together and blended to produce a relatively intermingled shredded cheese product blend.

23. A method of preparing a shredded cheese product blend, comprising:
shredding a segment of cheese to produce cheese shreds of a desired approximate size and configuration;
providing vegetable and/or fruit particles having a desired approximate size and having a moisture content which is less than approximately twenty-five percent;
adding said vegetable and/or fruit particles to said cheese shreds in a predetermined ratio;
blending said cheese shreds and said vegetable and/or fruit particles to produce a relatively intermingled shredded cheese product blend; and
packaging said shredded cheese product blend.

24. A method of preparing a shredded cheese product blend, comprising:
shredding a segment of cheese to produce cheese shreds of a desired approximate size and configuration;
providing vegetable and/or fruit particles having a desired approximate size and having a moisture content which is less than approximately twenty-five percent;
mixing at least one seasoning with said vegetable and/or fruit particles to produce a dry ingredients blend;
adding said dry ingredients blend to said cheese shreds in a predetermined ratio;
blending said cheese shreds and said dry ingredients blend to produce a relatively intermingled shredded cheese product blend; and
packaging said shredded cheese product blend.

25. A method of preparing a shredded cheese product blend, comprising:
shredding cheese to produce shredded cheese;
providing vegetable and/or fruit particles having a moisture content which is less than approximately twenty-five percent;
adding said vegetable and/or fruit particles to said cheese shreds in a predetermined ratio of between approximately 80% to approximately 99.5% by weight shredded cheese and approximately 0.5% to approximately 20% by weight vegetable and/or fruit particles;
blending said shredded cheese and said vegetable and/or fruit particles to produce a relatively intermingled shredded cheese product blend.
